(19) United States
(12) Patent Application Publication
(10) Pub. No.: US 2007/0049187 A1
(43) Pub. Date: Mar. 1, 2007

(54) LE's portable oyster opener

(76) Inventor: Chi Le, Westwego, LA (US)

Correspondence Address: CHI LE, P.O. BOX 842, WESTWEGO, LA, 70096-0842, US

(21) Appl. No.: 11/186,017

(22) Filed: Jul. 20, 2005

(51) Int. Cl. A22C 29/04

(52) U.S. Cl. 452/13

(57) ABSTRACT

An apparatus is electrically powered and the automatically forces acting method uses for open oyster shells, whichese serves as a catalyst from the torque rotation to double pushes and pulls directions for moving up and down pressed the opener's momentum through oyster seam is open the shells. An opener is long inclined teeth blade and wedge shaped; the opener may open all sizes of oyster by the technique of the normal force or the combining of the shearing and sliding forces. At almost the same of the normal force technique above; but in this techniques of the forces combination, either shell for forcing must parallel to the angle of the opener. When the opener's momentum coming down pushes on the shell; the shearing deformation exerts a sliding frictional force to broke the oyster eye, the shells slides off each other; the oyster shells is opened.

### DETAIL DESCRIPTION

The Portable oyster opener is an apparatus powered by 4 devices: an electric motor (1), a speed reducer (5), the transmission arms (4, 3, and 8) and the arbor press(es) (7). The opener (2) utilizes these components to work together conjunctly and efficiently.

The electric motor's strong force pushes in between the oyster seam to open the oyster and expose the soft, puby of the oyster meat.

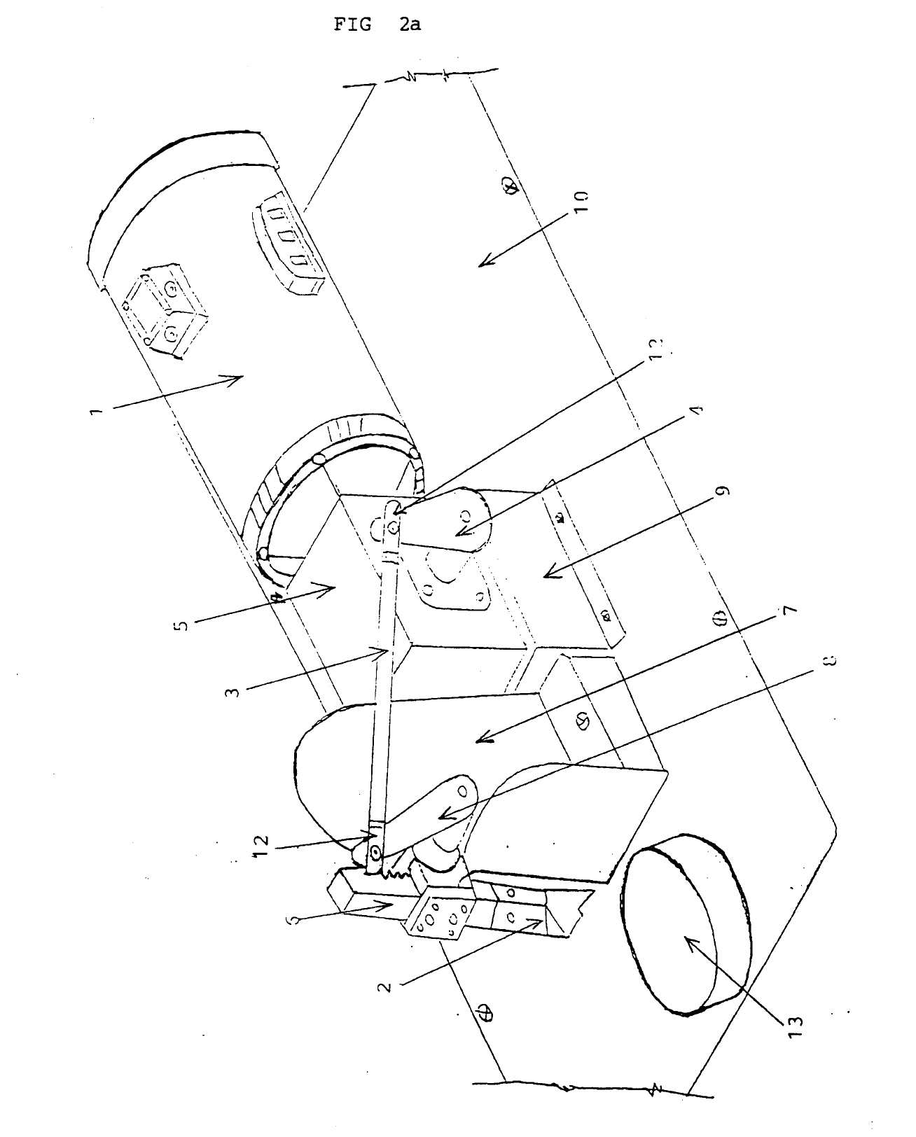

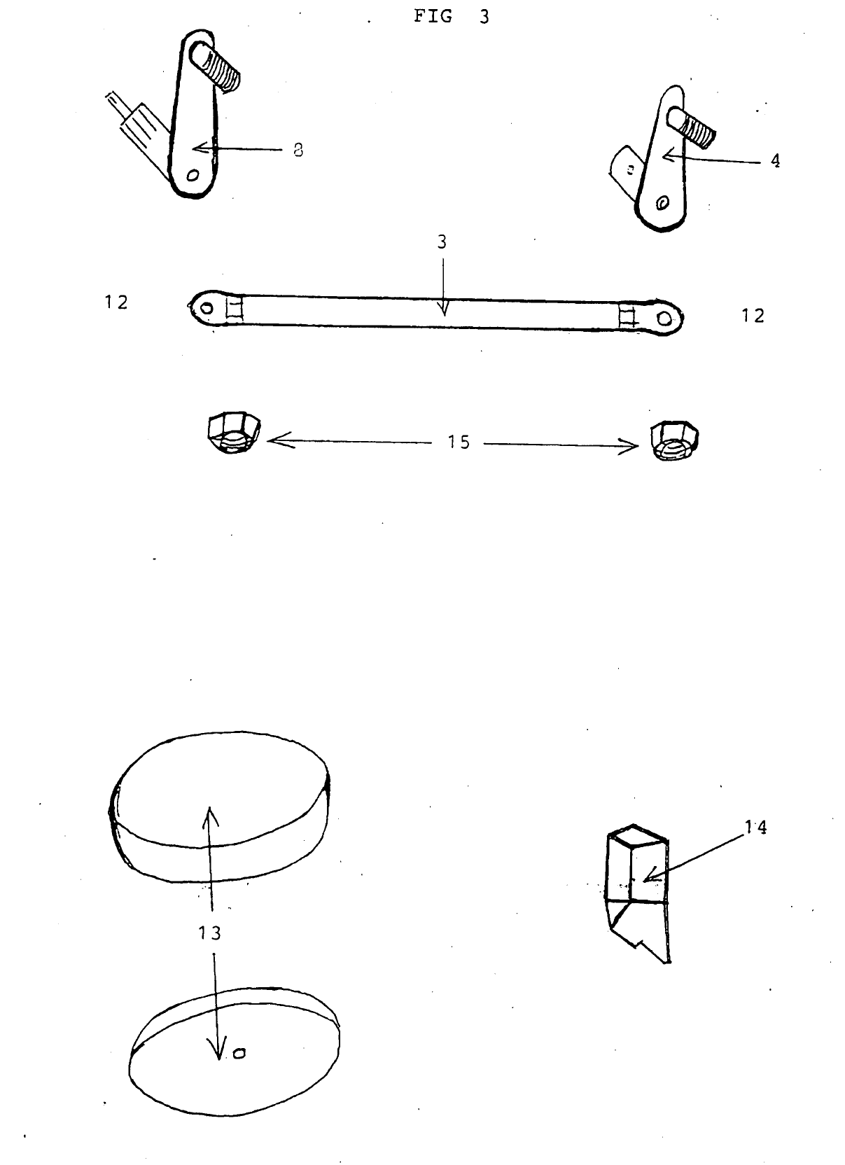

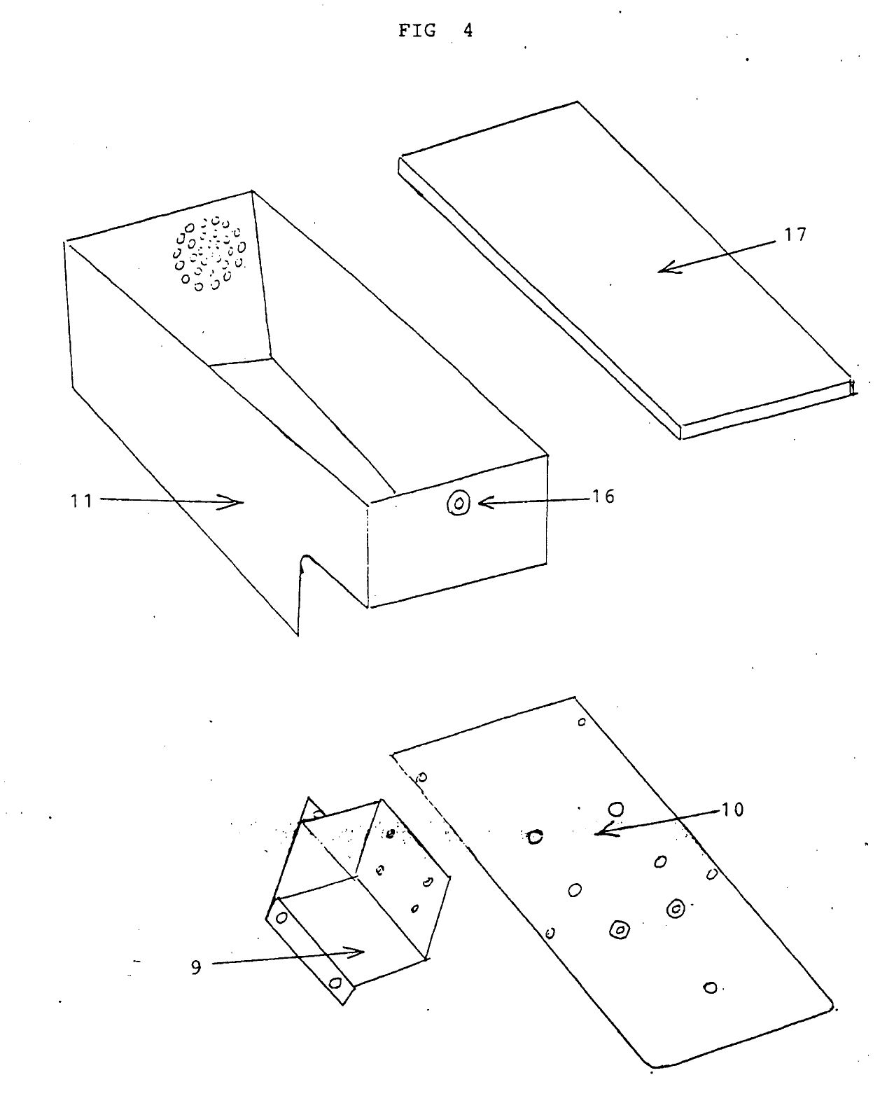

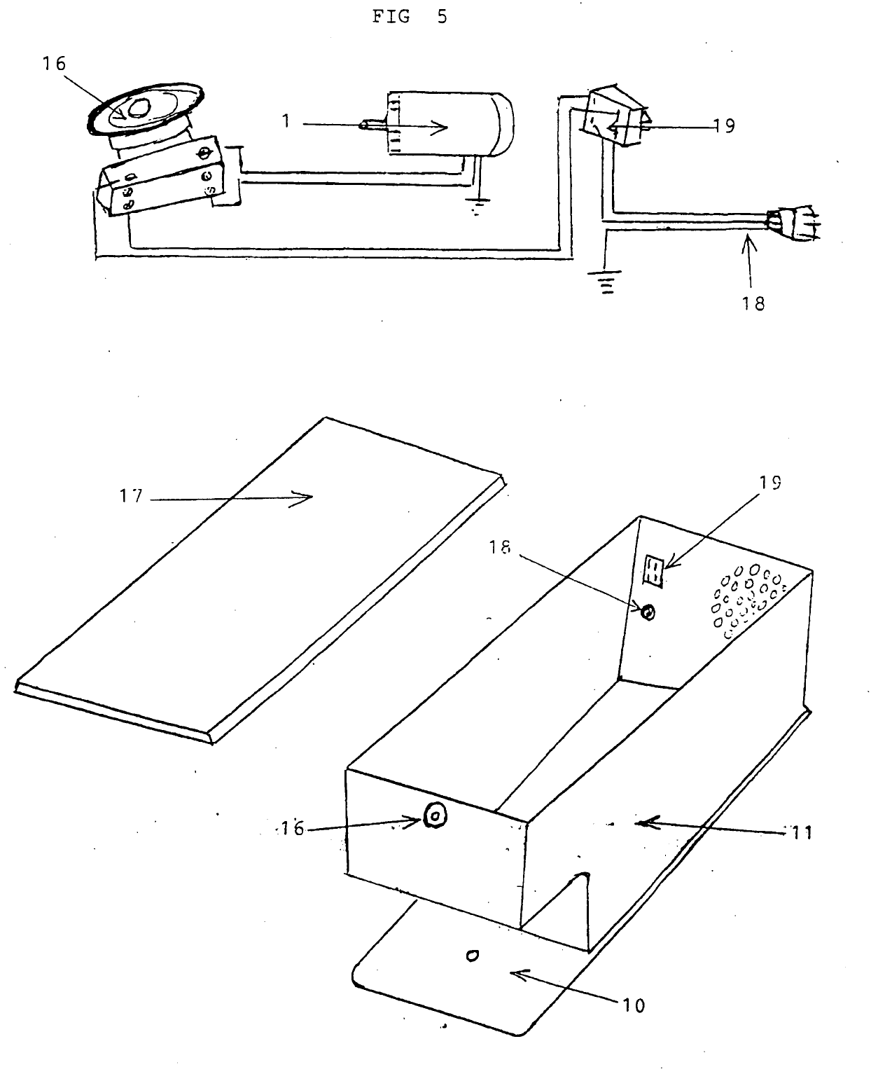

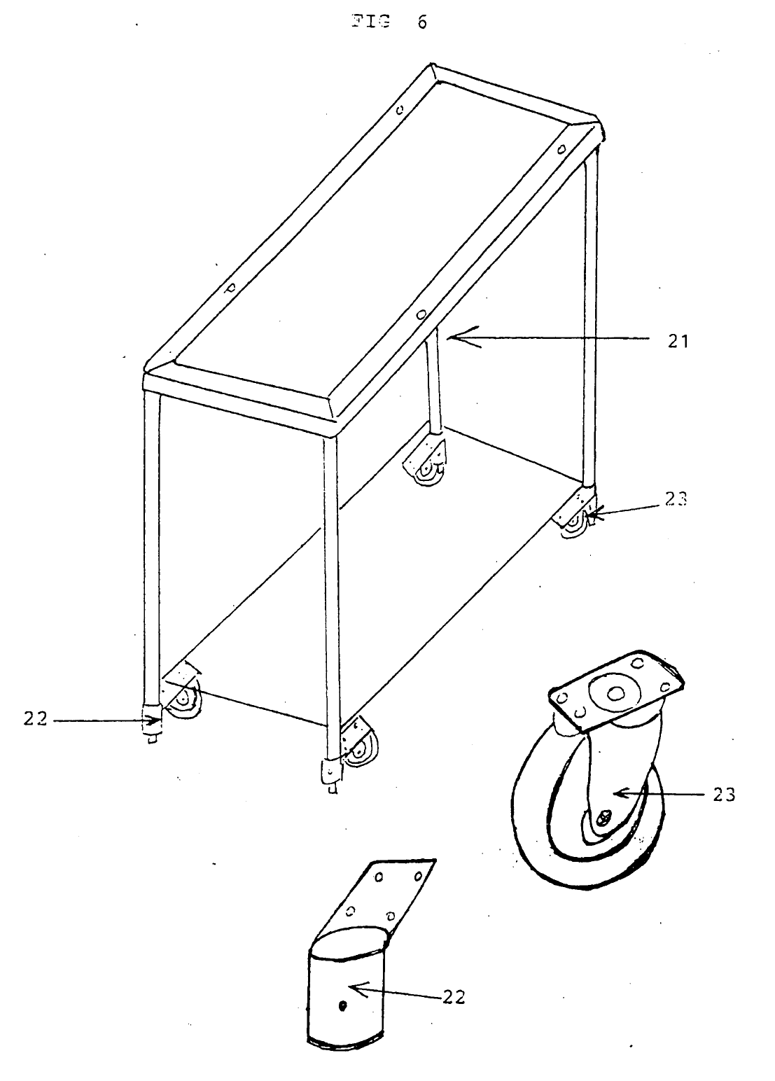

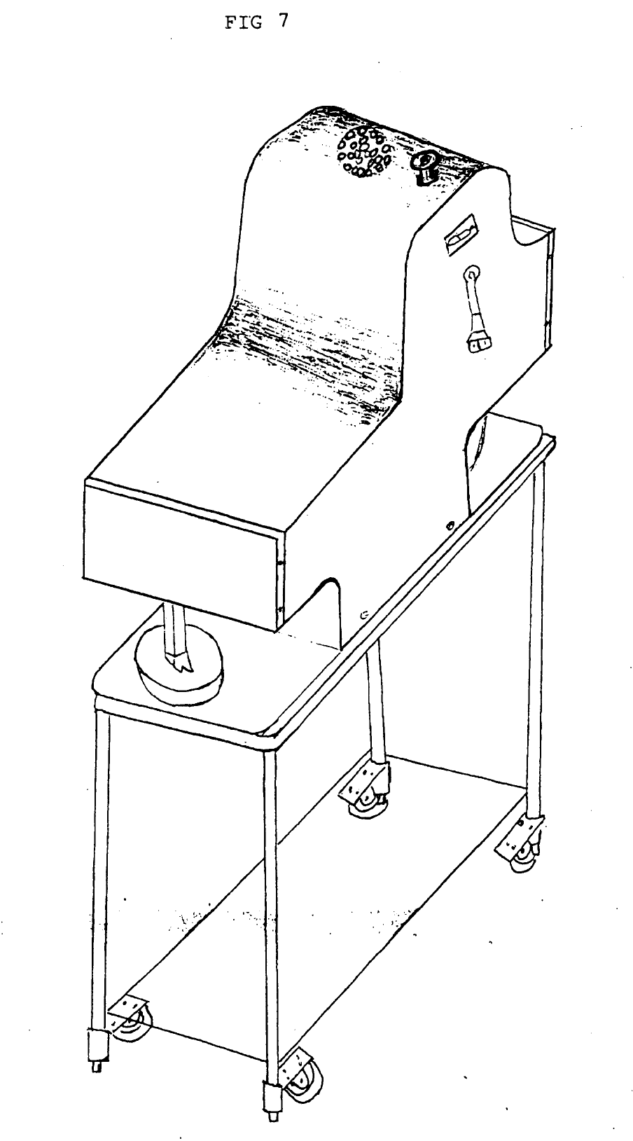

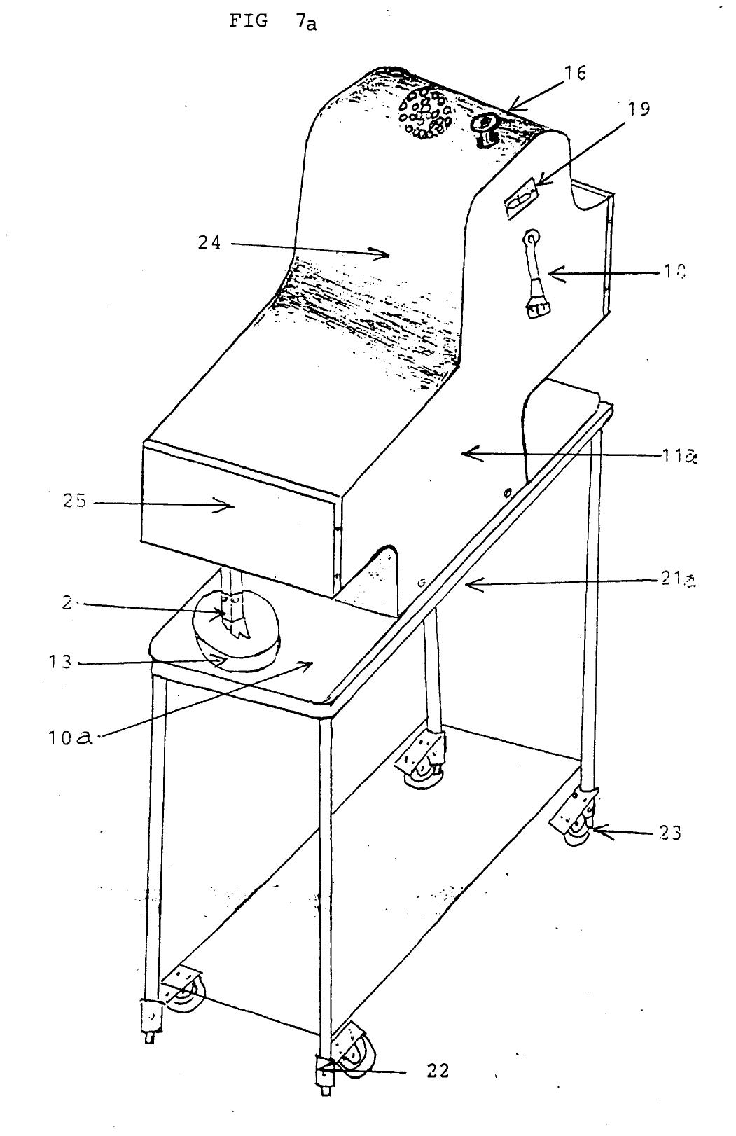

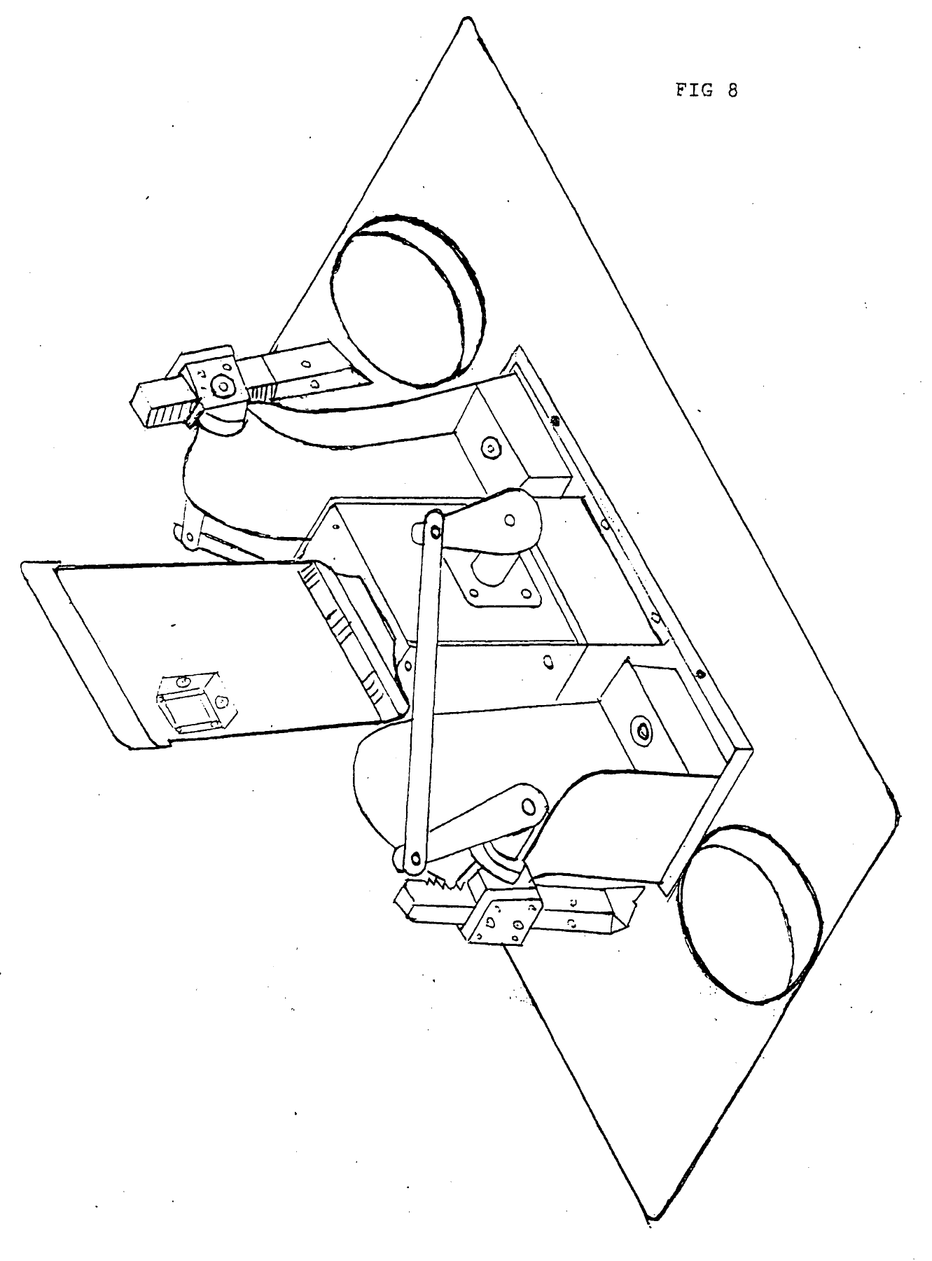

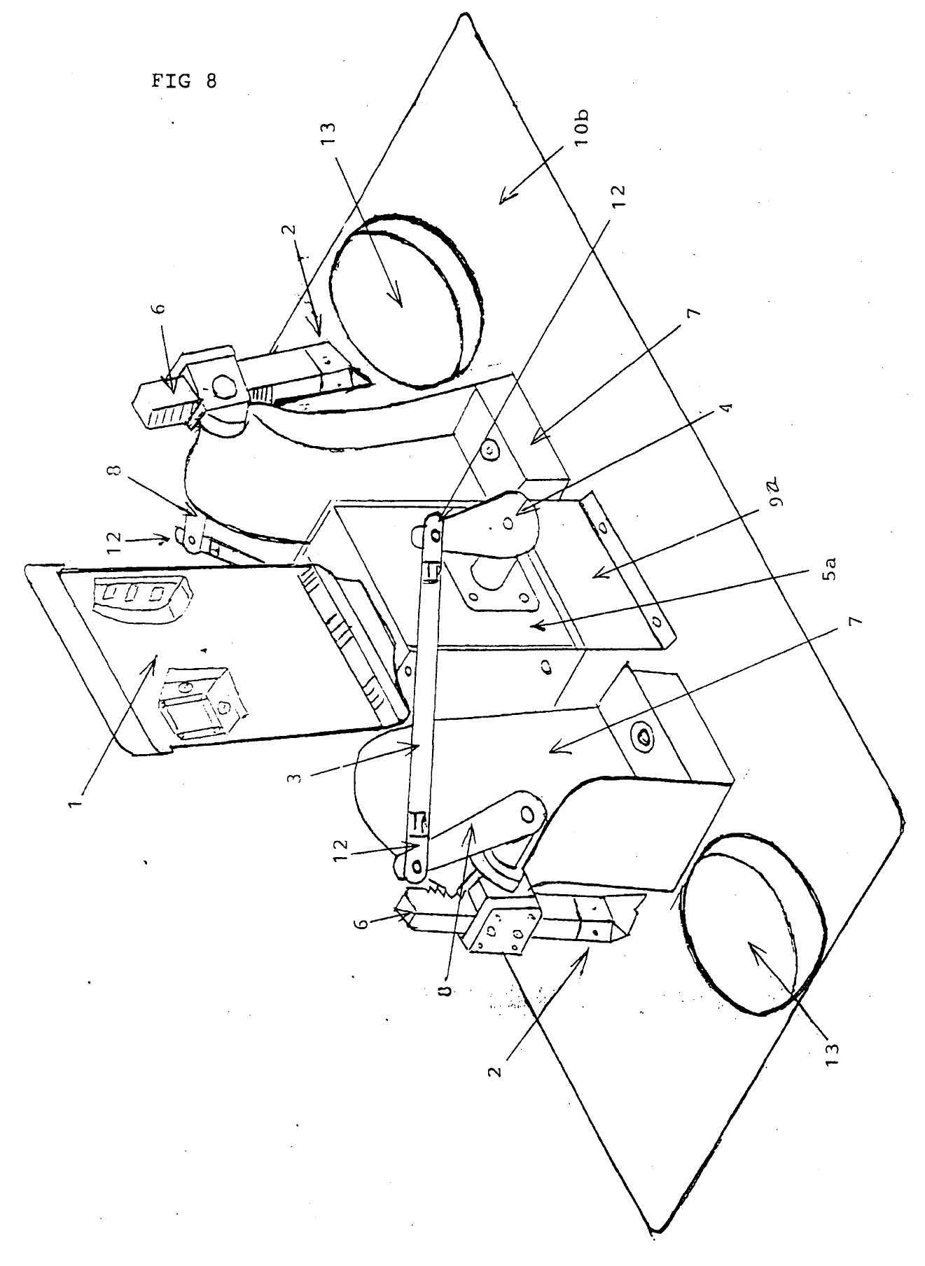

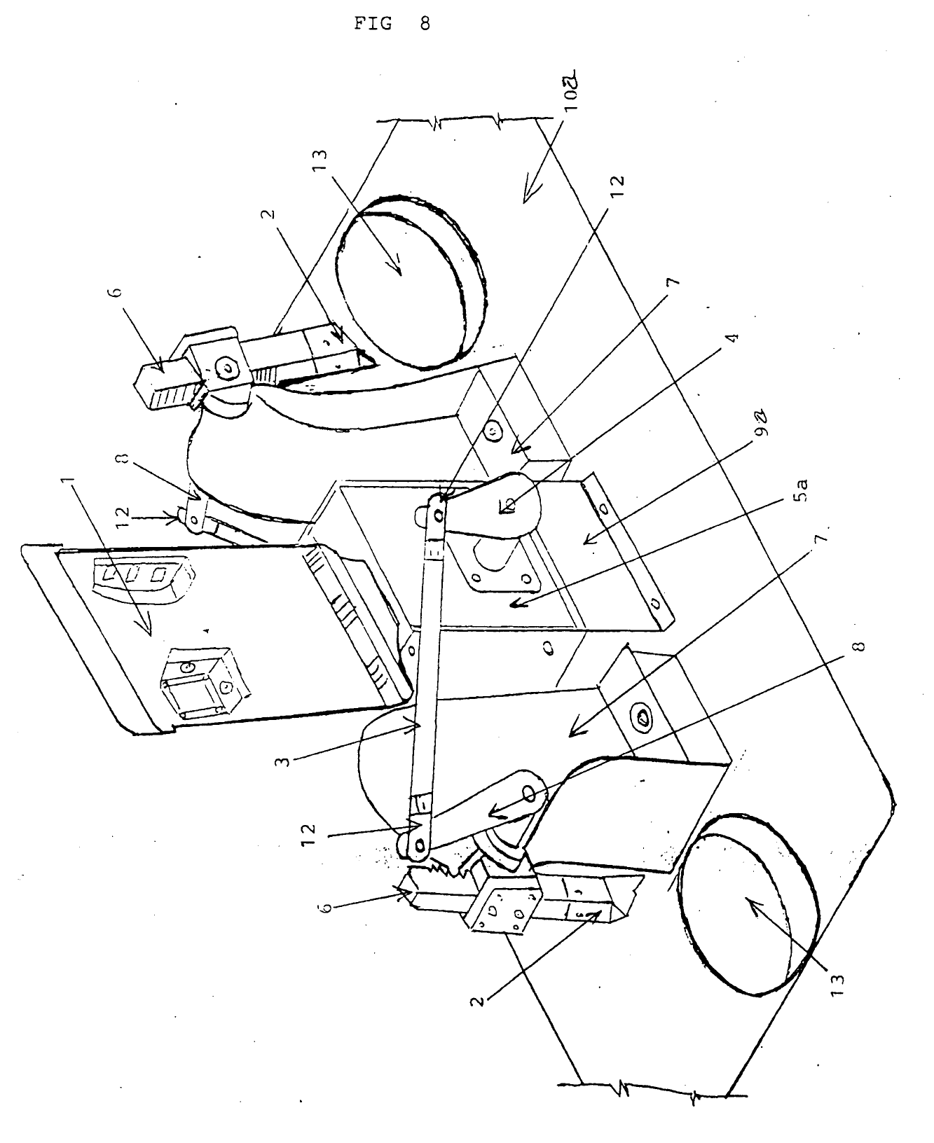

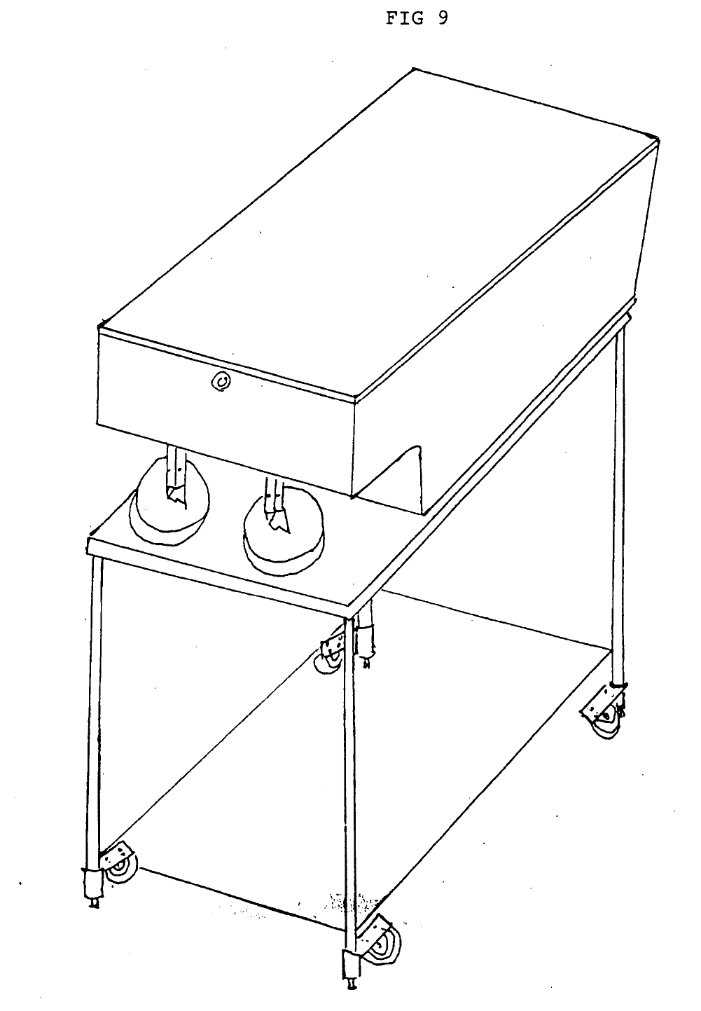

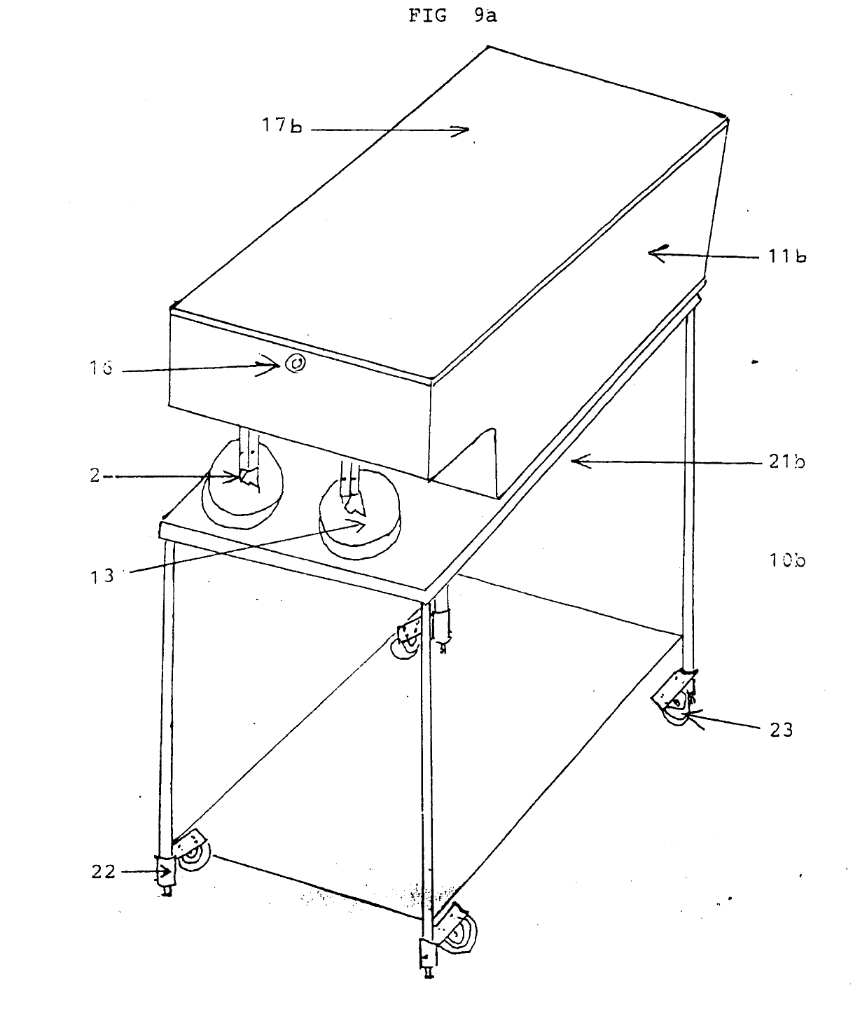

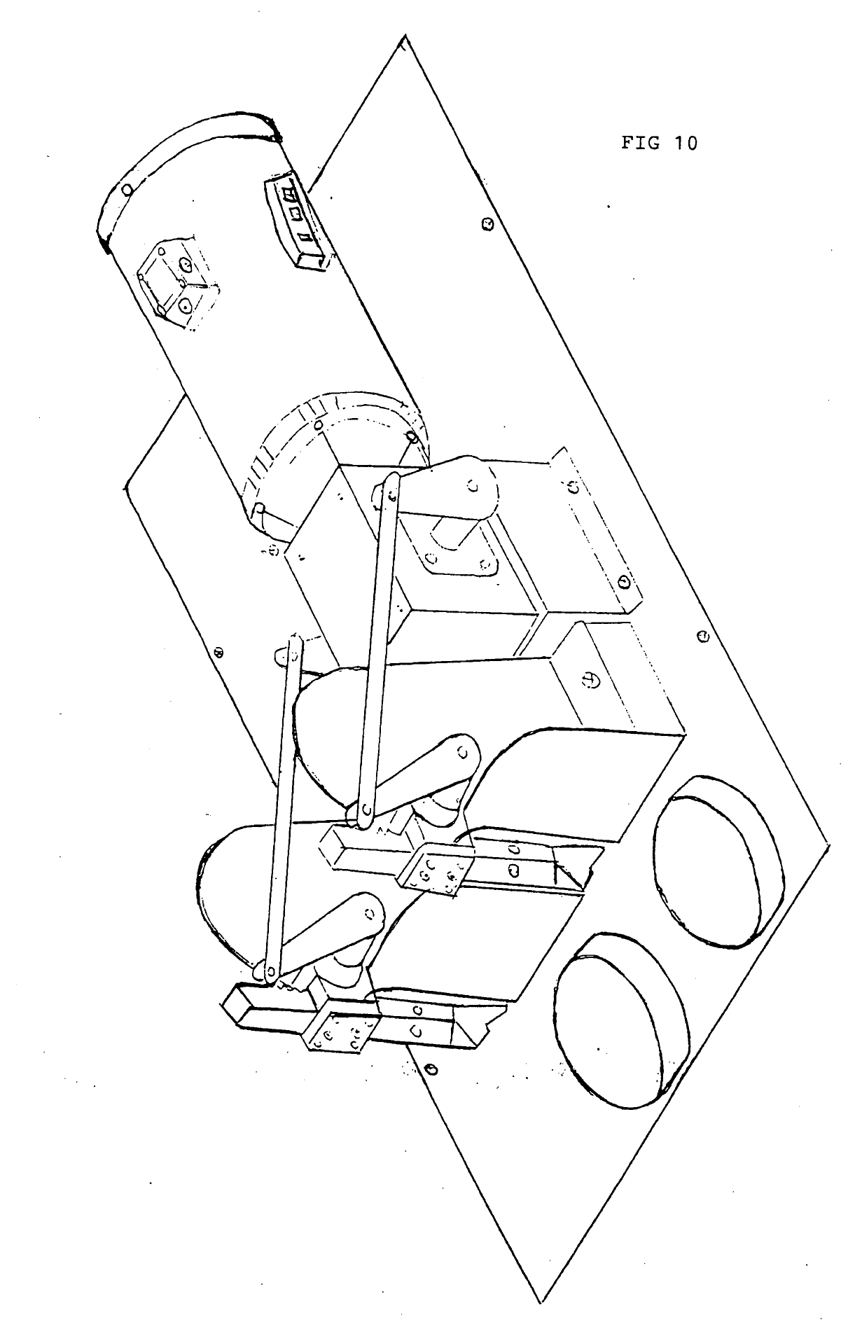

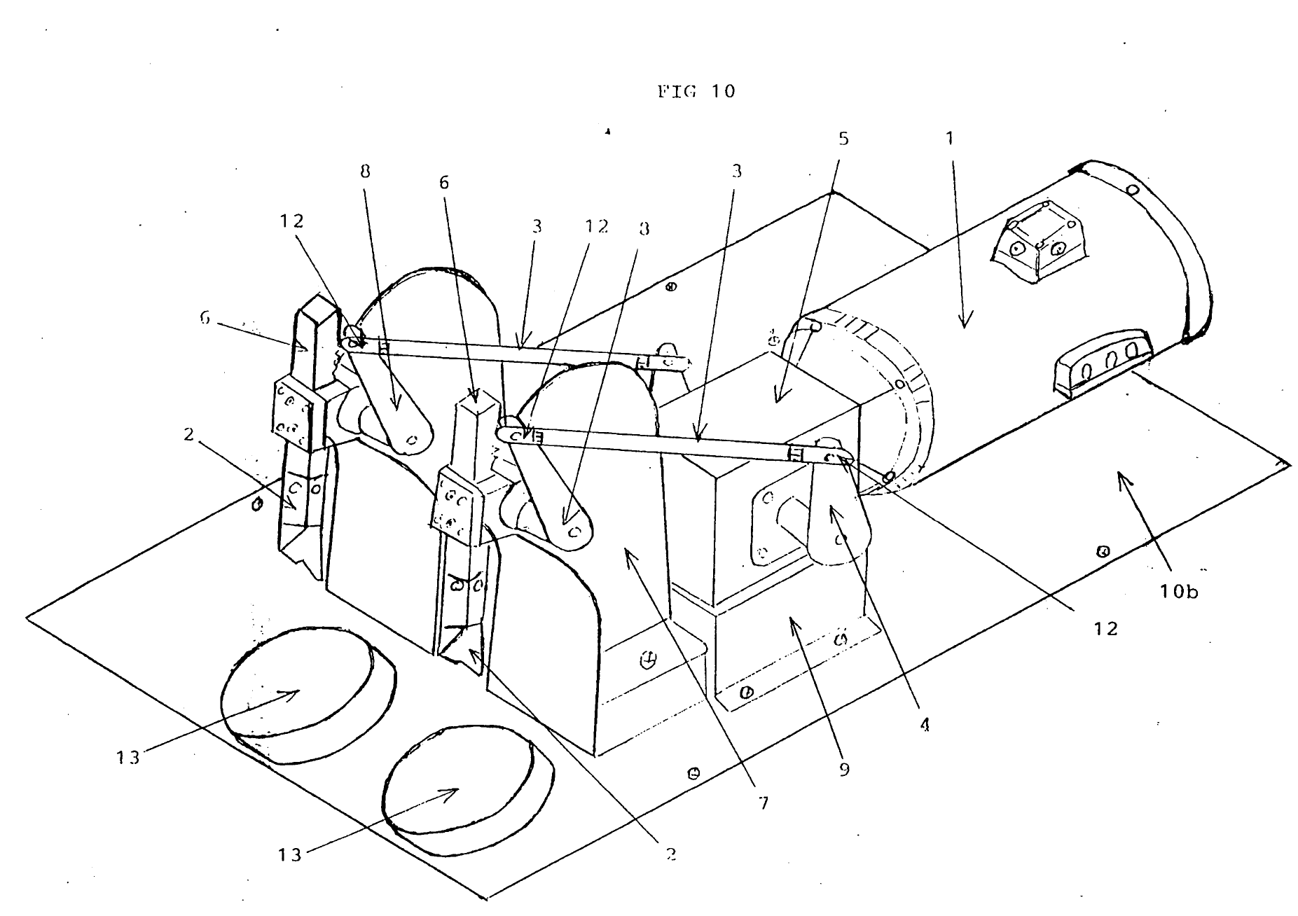

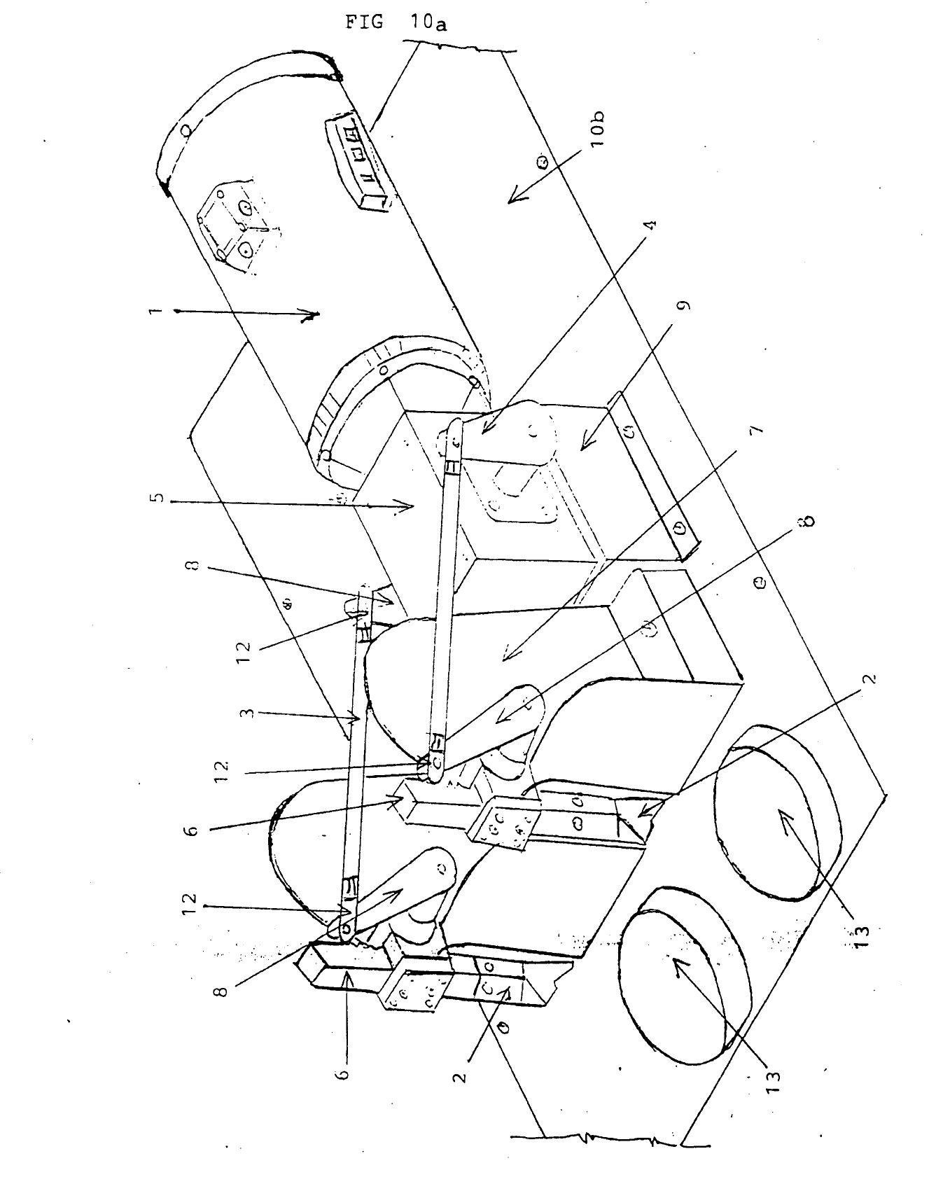

Each revolution of the apparatus (FIG. 2, FIG. 8, and FIG. 10) or the opener(s) (2) is determined by the speed at out-put of the speed reducer (5) which serves as a catalyst for movement of the rack (6) or the opener (2) because the opener(2) is adapted on the end of the rack (6). Ultimately, the pressure from these devices become so strong, that the shell part and the meat is exposed for easier accessibility.

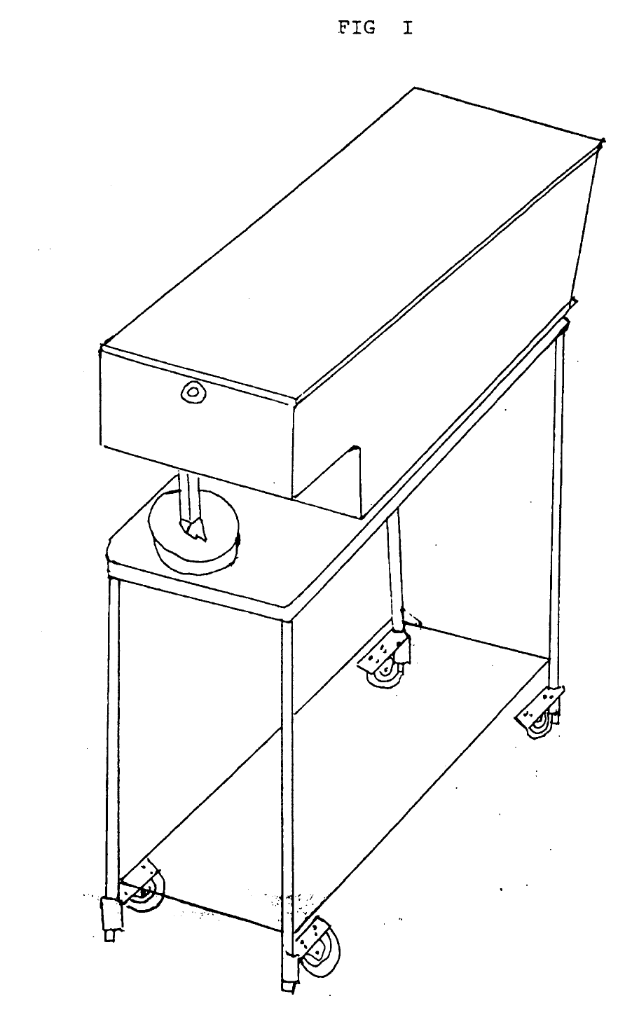

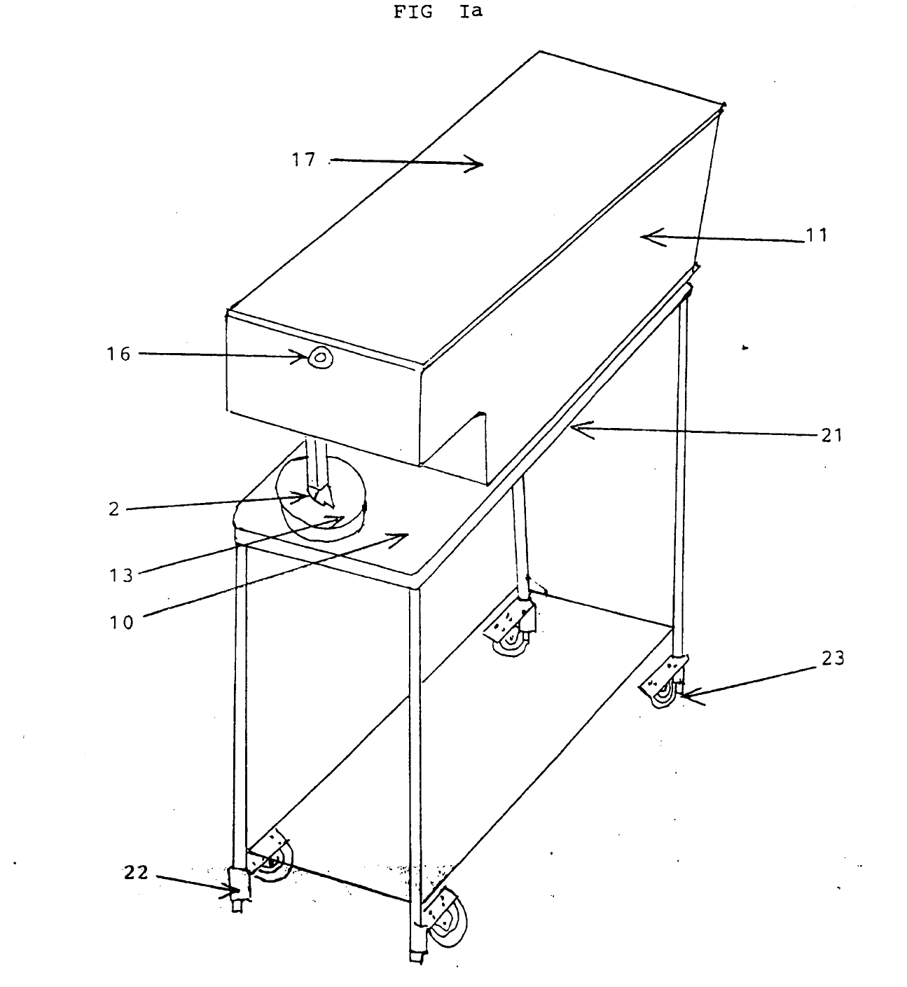

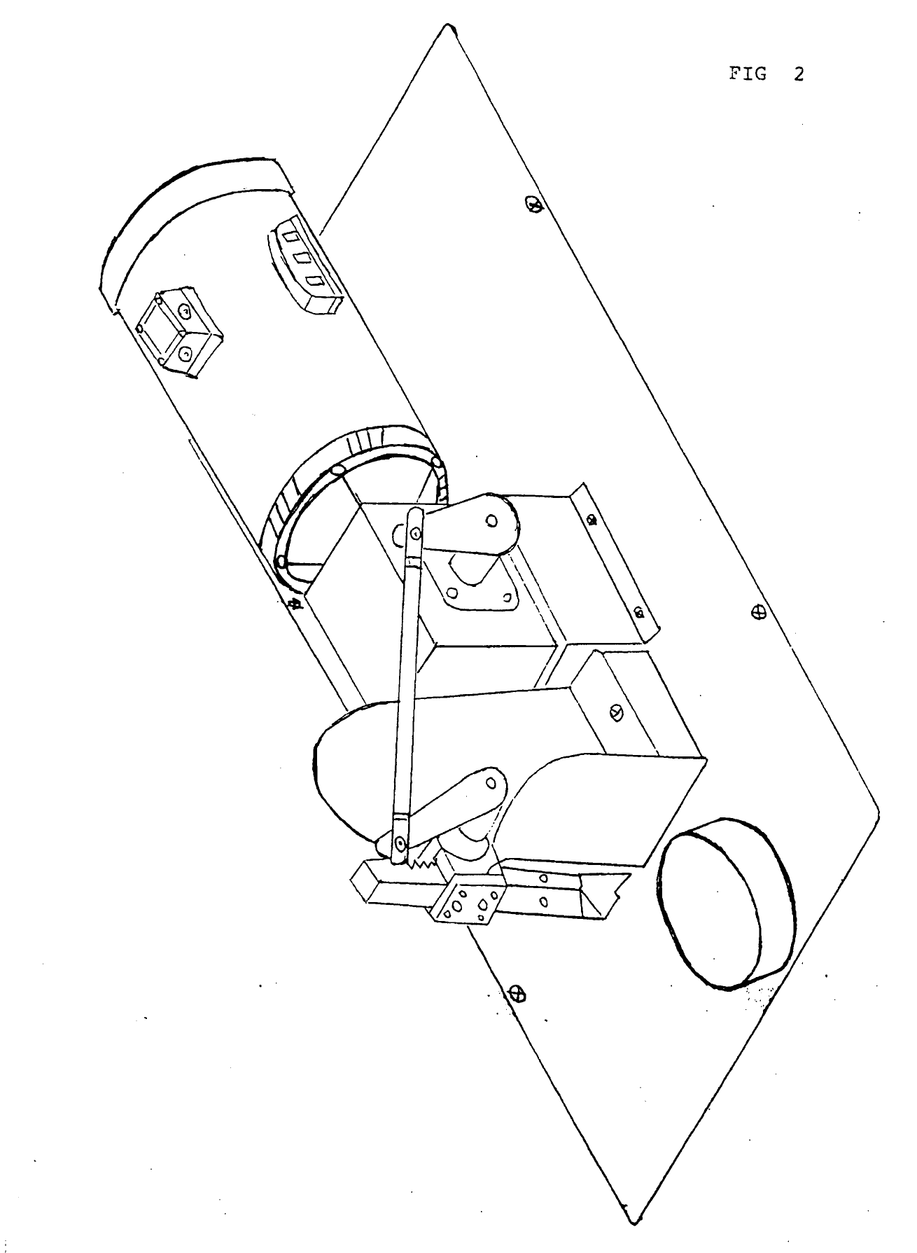

The apparatus technically may tranfigures from single opener (FIG. 2) to double openers (FIG. 8 and 10) are exactly the same but the securely metal boxes shaped are difference only (FIG. 1, 7, 9)

The Portable oyster opener has the unprendented ability to open between 40 to 60 oyster shells per minute and can increases in productivity depending on the operator and frequency of use. Furthermore, because of the motor's speed, this invention has an out-put capacity of 175 hits per minute in its opening procedure.

1. What I claim as My invention is the Le's Portable Oyster Opener the electrical operated; machine allow individual to open oyster shell without the use of hand hammer, so that the oyster can removed from the shell by individual.

2. What I claim as my invention is the Le's Portable Oyster Opener The machine is manual operated. The machine allows a individual to open oyster shell without the use of a hand hammer that the oyster can removed from the shell by individual.
